(19) United States
(12) Patent Application Publication
(10) Pub. No.: US 2013/0339496 A1
(43) Pub. Date: Dec. 19, 2013

(54) ENTERPRISE DEVICE CONFIGURATION SYSTEM

(71) Applicants: GYAN PRAKASH, Beaverton, OR (US); HORMUZD M. KHOSRAVI, Portland, OR (US); RAJESH POORNACHANDRAN, Portland, OR (US); ABDUL M. BAILEY, Tigard, OR (US); Shahrokh SHAHIDZADEH, Beaverton, OR (US)

(72) Inventors: GYAN PRAKASH, Beaverton, OR (US); HORMUZD M. KHOSRAVI, Portland, OR (US); RAJESH POORNACHANDRAN, Portland, OR (US); ABDUL M. BAILEY, Tigard, OR (US); Shahrokh SHAHIDZADEH, Beaverton, OR (US)

(21) Appl. No.: 13/706,708

(22) Filed: Dec. 6, 2012

Related U.S. Application Data
(63) Continuation-in-part of application No. 13/525,210, filed on Jun. 15, 2012.

(51) Int. Cl. G06F 15/177

(52) U.S. Cl. CPC G06F 15/177
USPC 709/220

(57) ABSTRACT

The present disclosure generally relates to a system and method for enterprise device customization. An example system may comprise an enterprise customization service and a device. The enterprise customization service may be configured to provide at least one of configuration or software to the device based on enterprise customization data. The device may include at least an enterprise customization application and the enterprise customization data. The enterprise customization application may be configured to cause the enterprise customization service to at least one of configure the device or to download software to the device based on the enterprise customization data.

### PRIORITY

The present U.S. Patent Application is a Continuation-in-Part (CIP) of co-pending U.S. patent application Ser. No. 13/525,210 entitled “Bundled Mobile Device Purchase System” and having a filing date of Jun. 15, 2012. The contents of the above-identified U.S. Patent Application are incorporated herein, in entirety, by reference.

### FIELD

The present disclosure is directed to a device configuration system, and more particularly, to a device configuration system capable of configuring devices wirelessly.

### BACKGROUND

A user may purchase a mobile device (e.g., a smartphone) and may later purchase one or more applications (“apps”) for the mobile device. Apps may be purchased from app sources, for example, an app store. Such purchases typically require configuration of the mobile device with user's personal data such as e-mail, credit card etc, access to the app store, selection of the app, payment for the app and download of the app to the mobile device. Thus, purchasing an app for the mobile device is typically separate and disconnected from the purchase of the mobile device.

In some situations, an OEM/ODM (Original Equipment Manufacturer/Original Device Manufacturer) may preload one or more apps on a mobile device prior to purchase by an end-user. The preloaded apps are generally selected by the OEM/ODM and may not reflect the end-user's preferences.

Moreover, enterprises (e.g., various businesses, scholastic institutions, hospitals, etc.) may also purchase mobile devices. These mobile devices are often purchased with the intent that the devices be used for organization-related purposes. While the enterprise may specify certain devices based on their reliability, compatibility with enterprise software, etc., enterprises may also be concerned about what software can be, or should be, loaded on the devices, the vulnerability of enterprise information stored on the devices, the manner in which the devices can be utilized by their employees, etc. As a result, enterprises will usually customize generic devices internally prior to distributing them to their employees. Customization may vary depending on, for example, the size of the enterprise, the type of enterprise, the location of the employee, the employee's work group, etc. This diversity means that mobile device management in large enterprises may require substantial internal resources for customizing a multitude of devices for different users, possibly resulting in high cost and substantial delays in distributing mobile devices.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a bundled mobile device purchase system consistent with various embodiments of the present disclosure;

FIG. 2 illustrates a flowchart of exemplary operations for purchasing a bundled mobile device consistent with an embodiment of the present disclosure;

FIG. 3 illustrates a flowchart of exemplary operations for downloading app(s), service(s) and/or rewards to a mobile device consistent with an embodiment of the present disclosure.

FIG. 4 illustrates an enterprise device configuration system consistent with various embodiments of the present disclosure;

FIG. 5 illustrates examples of package determination consistent with various embodiments of the present disclosure;

FIG. 6 illustrates a flowchart of exemplary operations for procuring devices consistent with an embodiment of the present disclosure;

FIG. 7 illustrates a flowchart of exemplary operations for providing enterprise configuration data to devices consistent with an embodiment of the present disclosure; and

FIG. 8 illustrates a flowchart of exemplary operations for customizing a device consistent with an embodiment of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure relates to a bundled mobile device purchase system. An apparatus, system and method consistent with the present disclosure are configured to allow purchase of applications (“apps”) and/or services and/or acceptance of rewards during a transaction to purchase a mobile device (i.e., “bundled” with the mobile device). The reseller may then store a bundle identifier (“bundle ID”) related to the product bundle in the purchased mobile device. For example, the bundle ID may include an identifier associated with each app, service and/or reward. The bundle ID may further include user purchase details. User purchase details may include, but are not limited to, a unique purchase identifier such as a sales receipt number. The bundle ID may be stored in the mobile device without powering up (i.e., powering on) the mobile device by the reseller. For example, the bundle ID may be stored in the mobile device without removing the mobile device from its packaging (i.e., “new, in box”). The apps, services and/or rewards may then be downloaded to the mobile device (from, for example, the cloud) and/or offered to the user after the purchase transaction, for example, in response to mobile device power up (e.g., initial mobile device power up by the user), in response to a user request and/or in response to update(s) to app(s), service(s) and/or reward(s).

Apps may include, but are not limited to, educational apps, entertainment apps (e.g., games), informational apps (e.g., news, weather, personal navigation), health related apps (e.g., diet, exercise) and/or other apps known to those skilled in the art. Services may include, but are not limited to, cellular telephone service, internet service, discounted media content subscriptions, opening an online bank account with cash award, security (e.g., home, vehicle), navigation, information and/or other services known to those skilled in the art. Rewards may include, but are not limited to, rewards for purchasing app(s) and/or service(s), reward offers for later purchases of app(s) and/or service(s), coupons, gift cards and/or other rewards known to those skilled in the art.

Thus, a reseller may offer app(s), service(s) and/or reward(s) to a user during a mobile device purchase transaction by the user. The user may select one or more app(s) and/or service(s) for purchase with the mobile device. The user may further agree to accept one or more rewards (e.g., coupons) associated with the purchase of app(s), service(s) and/or the mobile device.

In this manner, sales and marketing channels for apps, for example, may be expanded to include resellers. A user that purchases a mobile device may benefit from customized selection of apps, services and rewards and thus avoid undesired apps, services and rewards. The user may further benefit by selecting the product bundle during the mobile device purchase transaction and the reseller may offer incentives to the user based on, e.g., a number of apps and/or services purchased and/or rewards accepted. Use of the bundle ID with later download/activation of app(s), service(s) and/or reward(s) is configured to allow the reseller to store the user selected/accepted app, service and/or reward identifiers in the mobile device without requiring powering up the mobile device.

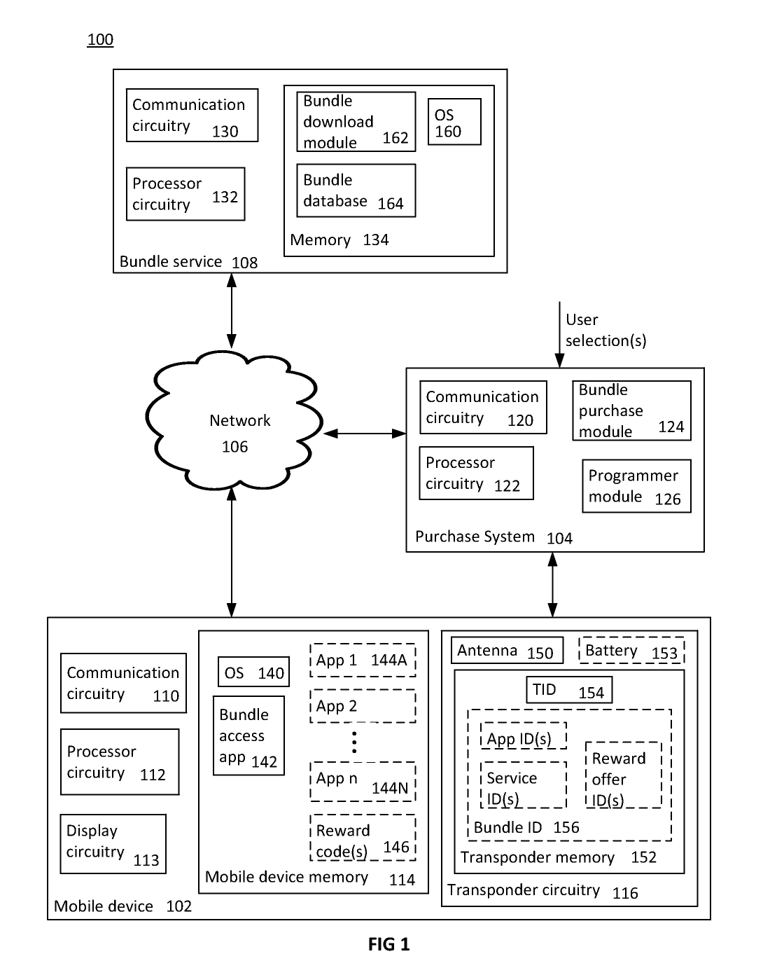

FIG. 1 illustrates a bundled mobile device purchase system 100 consistent with various embodiments of the present disclosure. The system 100 generally includes a mobile device 102, a purchase system 104, a network 106 and a bundle service 108. “Mobile device” as used herein means any handheld computing device configured to download and execute an app, including, but not limited to, mobile telephones, smartphones, feature phones, tablet computers, ultraportable computers, ultramobile computers, netbook computers, subnotebook computers, personal digital assistants, enterprise digital assistants, mobile internet devices and personal navigation devices.

Mobile device 102 and purchase system 104 include communication circuitry 110 and 120, respectively, and processor circuitry 112 and 122, respectively. Communication circuitry 110 and 120 are configured to transmit and receive one or more signals that comply and/or are compatible with one or more communication protocols. As used herein, signals and/or communication protocols include but are not limited to NFC (Near Field Communication), RFID (Radio frequency identification), Bluetooth, Wi-Fi, 3G, 4G and/or other communication protocols. Mobile device 102 and purchase system 104 are configured to communicate via one or more of these communication protocols. For example, purchase system 104 may be configured to communicate with mobile device 102 using NFC or RFID to provide the bundle ID to the mobile device 102. In another example, purchase system 104 and/or mobile device 102 may be configured to communicate with bundle service 108 via network 106 using, e.g., Wi-Fi. Processor circuitry 112 is configured to perform operations associated with one or more applications included in mobile device 102. Processor circuitry 122 is configured to perform operations associated with purchase system 104.

Mobile device 102 includes display circuitry 113, memory 114 and transponder circuitry 116. Display circuitry 113 is configured to display information to the user as described herein. Display circuitry may be further configured to receive user inputs. For example, display circuitry may include a touch screen. Mobile device memory 114 is configured to store mobile device operating system (OS 140, bundle access app 142 and one or more app(s) 144A, . . . , 144N and/or reward code(s) 146.

Transponder circuitry 116 includes an antenna 150 and transponder memory 152. Transponder memory 152 is configured to store a transponder identifier TID 154 and a bundle identifier (“bundle ID”) 156. For example, transponder circuitry 116 may be an RFID module. In another example, transponder circuitry 116 may be an NFC module. In some embodiments, transponder circuitry 116 may include a battery 153. The battery 153 is configured to provide power to communication circuitry 110, if, for example, purchase system 104 provides the bundle ID 156 to the mobile device using Wi-Fi, 3G or 4G.

At manufacturing, mobile device 102 may be configured without app(s) 144A, . . . , 144N, without reward codes 146 and without bundle ID 156. Mobile device 102 may be provisioned with TID 154 (e.g., device serial number) configured to uniquely identify mobile device 102. A reseller may utilize purchase system 104 to generate the bundle ID based, at least in part, on user selections of bundled product during the purchase transaction of mobile device 102. For example, a reseller may be a physical entity (i.e., “bricks and mortar”) so that the user/purchaser is local to the purchase system 104 during the purchase transaction. In another example, the reseller may be accessed by a user/purchaser remotely via a network, e.g., network 106.

The user may select one or more app(s) and/or service(s) for purchase during the transaction to purchase the mobile device 102. The user may be offered one or more reward(s) during the transaction. The reward(s) may be related to the app(s), service(s) and/or mobile device purchased and/or may be related to possible future purchases. The user may choose to accept or reject offered reward(s). Each app, service and reward may be identified by a unique identifier. For example, each identifier may be numeric. In another example, one or more identifiers may be alpha numeric. The bundle ID 156 may then be generated based, at least in part, on the app, service and reward identifiers. For example, the bundle ID 156 may include a concatenation of the app, service and reward identifiers. In some embodiments, the bundle ID 156 may further include an indicator of the number of app(s) and/or service(s) purchased. In some embodiments, the bundle ID 156 may further include a unique purchase identifier, for example, a sales receipt number. In some embodiments, at least some identifiers may be configured to allow a user to select which app(s) to download and/or which service(s) to activate, as described herein.

Purchase system 104 includes a bundle purchase module 124 and a programmer module 126. Purchase system 104 is configured to provide the bundle ID to transponder circuitry 116. Purchase system 104 may be temporarily coupled to transponder circuitry 116 in order to provide the bundle ID 156 to transponder circuitry 116. For example, the purchase system 104 may be configured to communicate wirelessly with transponder circuitry 116 via antenna 150. Such wireless communication may include NFC (Near Field Communication), RFID, Bluetooth and/or other communication protocols.

Bundle purchase module 124 is configured to receive user selection(s) during the mobile device 102 purchase transaction. The bundle purchase module 124 is then configured to generate the bundle ID 156 and to provide the bundle ID 156 to the mobile device 102 using the programmer module 126. Bundle purchase module 124 may be configured to provide a listing of available app(s) and/or service(s) to the user and to receive the user's selection(s). The bundle purchase module 124 may be further configured to provide reward offer(s) to the user based on, for example, the app(s) and/or service(s) selected for purchase and/or characteristics of the mobile device 102. In some embodiments, the app(s) and/or service(s) may be related to the mobile device 102.

Thus, one or more app(s) and/or service(s) may be purchased during a transaction to purchase a mobile device, e.g., mobile device 102. One or more reward(s) may be offered during this purchase transaction. A bundle ID may then be generated configured to identify the purchased app(s) and/or service(s) and accepted reward(s). The bundle ID may further include a unique purchase identifier. The bundle ID may then be stored in the purchased mobile device using, for example, NFC and/or RFID, enabling storage in the mobile device without powering up the mobile device (e.g., via passive radio frequency (RF) wireless interaction, such as based on the EPCglobal Generation 2 (“Gen 2”) standard, Revision 1.2.0). Thus, app and service purchases may be combined with the purchase of the mobile device at a reseller. The app(s) and service(s) purchased may be generally user-selected based on user preferences, avoiding apps and services not desired by the user.

After the bundle ID 156 has been stored in the mobile device 102 by the reseller, the mobile device may be provided to the user. If the purchase transaction was performed locally, the user may be provided the mobile device at the reseller's location.

If the purchase transaction was performed remotely, the mobile device 102, including bundle ID 156 stored in the transponder memory 152, may be shipped to the user. The purchased app(s) may then be downloaded to the mobile device 102, the purchased service(s) may then be activated and/or the accepted reward(s) may be redeemed after receipt of the mobile device 102 by the user. In response to mobile device 102 being powered up and/or in response to a user selection, bundle access app 142 may be configured to execute to couple mobile device 102 to bundle service 108 via, for example, network 106.

Bundle service 108 may include communication circuitry 130, one or more processor(s) (“processor circuitry”) 132, and memory 134. Bundle service 108 may correspond to one or more servers in a plurality of servers, i.e., may be in the cloud. Processor circuitry 132 is configured to perform operations associated with system 100 and bundle service 108. Communication circuitry 130 is configured to communicate, wired and/or wirelessly, with mobile device 102 and/or purchase system 104 via network 106, using one or more communication protocols, as described herein. The communication protocols may include, but are not limited to, Wi-Fi, Bluetooth, 3G, 4G and/or some other communication protocol.

Bundle service memory 134 may include operating system OS 160, bundle download module 162 and bundle database 164. Bundle download module 162 is configured to manage download of purchased app(s) and accepted reward(s) to mobile device 102 and activation of purchased service(s) in response to a request from bundle access app 142. Bundle download module 162 may be further configured to offer updated app(s), service(s) and/or reward(s) to a user via mobile device 102. Bundle database 164 is configured to store a plurality of app(s) and associated app identifiers, a plurality of service descriptor(s) and associated service identifiers and a plurality of reward offer descriptors and associated reward identifiers (e.g., reward codes).

For example, in response to power up of mobile device 102 and/or a user selection, bundle access app 142 is configured to read the bundle ID 156 from transponder memory 152. Bundle access app 142 is configured to parse the bundle ID 156 to determine the app, service and/or reward identifier(s). Bundle access app 142 may then couple the mobile device 102 to bundle service 108. Bundle access app 142 may then provide the identifiers to the bundle service 108 with a request to download app(s) and/or reward code(s) corresponding to the identifiers and to activate associated services(s).

In some embodiments, bundle access app 142 may be configured to display a listing of app(s), service(s) and/or reward code(s) to the user via display circuitry 113. The user may then select app(s) and/or reward code(s) to download and/or service(s) to activate. The listing may include updated app(s), service(s) and/or reward offer(s) received from bundle service 108.

Bundle download module 162 is configured to receive the request to download app(s) and/or reward code(s) and/or activate service(s) and the identifier(s) from the mobile device 102 (and bundle access app 142). The identifier(s) may include the unique purchase identifier. In response, bundle download module 162 is configured to access the bundle database 164, retrieve app(s) corresponding to received app identifiers and to provide the app(s) to mobile device 102. The app(s) 144A, . . . , 144N may then be stored in mobile device memory 114. Bundle download module 162 may be further configured to retrieve reward code(s) corresponding to reward identifiers and to provide these reward code(s) 146 to mobile device 102. The reward codes 146 may then be stored in mobile device memory 114. Bundle download module 162 may be configured to activate service(s) associated with service identifier(s) included in bundle ID 156 based on associated service descriptors included in bundle database 164. Bundle access app 142 may be further configured to display reward(s) and/or reward code(s) to the user after download to the mobile device.

In some embodiments, purchase system 104 may be configured to couple to bundle service 108 via network 106. For example, purchase system 104 may couple to bundle service 108 to determine available app(s) and/or service(s) and their associated identifier(s). In another example, purchase system 104 may determine available reward offers and associated identifiers. In another example, purchase system 104 may provide information related to a purchase transaction to bundle service 108. In this example, the TID 154 and bundle ID may be provided to the bundle service 108. Communication between purchase system 104 and bundle service 108 may occur separate from the bundled mobile device purchase transaction described herein.

Thus, app(s) and/or service(s) selected and purchased during the mobile device 102 purchase transaction and/or reward offer(s) accepted during the mobile device 102 purchase transaction may be identified using the bundle 156. The bundle ID 156 may be stored in the mobile device 102 during the purchase transaction by a reseller without powering up the mobile device 102. The app(s), service(s) and/or reward code(s) may then be downloaded and/or activated after the purchase transaction.

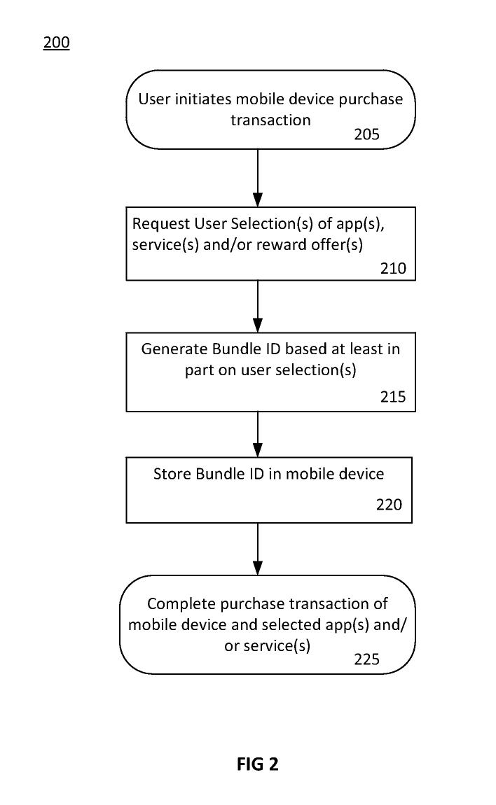

FIG. 2 illustrates a flowchart 200 of exemplary operations consistent with an embodiment of the present disclosure. The operations may be performed, for example, by the purchase system 104. In particular, flowchart 200 depicts exemplary operations configured to allow a user to purchase app(s) and/or service(s) and/or to accept reward offer(s) during a mobile device purchase transaction. The operations of flowchart 200 may begin 205 when a user initiates a mobile device purchase transaction. The user may be requested to select app(s), service(s) and/or reward offer(s). Reward offer(s) may be based, at least in part, on user selection(s) of app(s) and/or service(s). For example, if a user selects a number of app(s), a reward (e.g., gift card) may be offered. Operation 215 includes generating a bundle ID based at least in part on user selection(s). The bundle ID may include app identifiers, service identifiers and/or reward identifiers corresponding to the app(s) and/or service(s) that the user has selected for purchase along with the mobile device and any reward offers that the user has accepted. The bundle ID may further include a unique purchase identifier.

The bundle ID may be stored in the mobile device at operation 220. For example, the bundle ID may be stored in the mobile device by a reseller of the mobile device without powering up the mobile device. Program flow may end at operation 225 with completion of the mobile device purchase transaction. For example, completion of the mobile device purchase transaction may include receiving payment for the mobile device, app(s) and service(s) by the reseller. The mobile device purchase transaction includes selection and purchase of app(s) and/or service(s) and may include offer and acceptance of rewards.

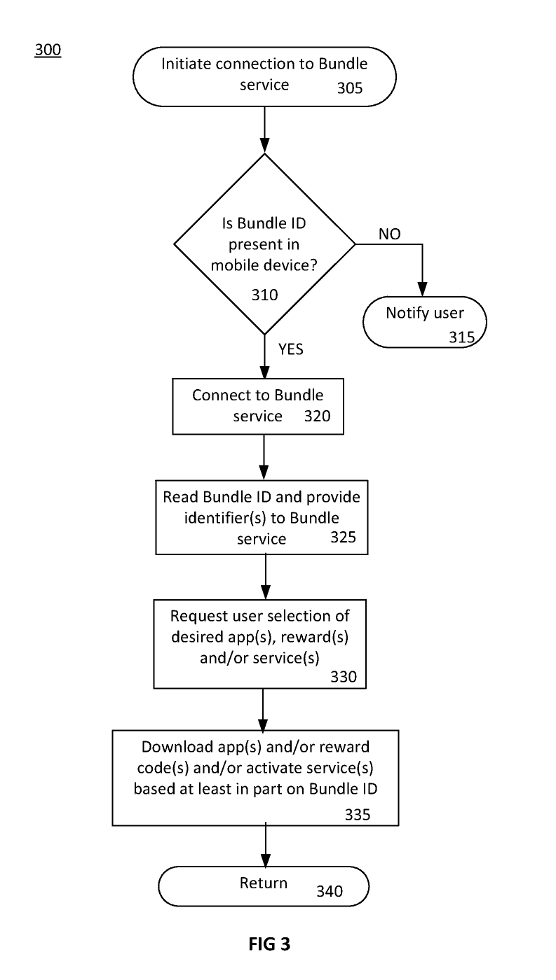

FIG. 3 illustrates a flowchart 300 of exemplary operations consistent with an embodiment of the present disclosure. The operations may be performed, for example, by mobile device 102 and bundle service 108. In particular, flowchart 300 depicts exemplary operations configured to download and store in the mobile device app(s) purchased during the mobile purchase transaction, activate service(s) purchased during the mobile device purchase transaction, download and store in the mobile device reward codes offered and accepted during the purchase transaction and/or receive update offers.

The operations of flowchart 300 may begin by initiating 305 connection to a bundle service. The connection to the bundle service may be initiated in response to power up of the mobile device (e.g., initial power up after the purchase transaction) and/or in response to a user request. For example, the user may receive notice of updated offers (app(s), service(s) and/or reward(s)) available. Whether a bundle ID is present in the mobile device may be determined at operation 310. For example, the bundle ID may be stored in nonvolatile memory included in transponder circuitry of the mobile device. If the bundle ID is not present, the user may be notified at operation 315.

If the bundle ID is present, connection to a bundle service may be established at operation 320. Operation 325 includes reading the bundle ID and providing identifiers to the bundle service. The identifier(s) included in the bundle ID may include app identifier(s), service identifier(s) and/or reward offer identifier(s) as described herein. Operation 330 may include requesting the user to select desired app(s), reward(s) and/or service(s). Additional cost(s), if any, may be communicated to the user, for example, if the cost of selected app(s) and/or service(s) exceeds the amount paid during the purchase transaction plus any associated rewards. The user may then choose to pay the difference or to change selections. Operation 335 includes downloading app(s) and/or reward code(s) based at least in part on the bundle ID. Operation 335 may further include activating service(s) based, at least in part, on the bundle ID. Program flow may return at operation 340.

Thus, the operations of flowcharts 200 and 300 are configured to allow a reseller to sell and a user to purchase app(s) and/or service(s) during a mobile device purchase transaction. The reseller may offer the user reward(s) during the transaction. The purchased app(s) may then be downloaded to the mobile device and the services activated after the purchase transaction. Reward code(s) may also be downloaded.

### Enterprise Device Configuration System

The following disclosure describes various exemplary systems and methods that may be implemented using equipment such as previously described in accordance with various embodiments consistent with the present disclosure. However, the following systems and methods are not intended to be limited to implementation with only the above-described hardware systems. References made to any of the above features are merely for the sake of explanation herein. Systems and methods such as described below may, in actuality, be implemented using any combination of equipment and software that is configurable to support the following disclosed example functionality, operations, etc.

While an example scenario wherein devices may be purchased by individual users having the ability to customize bundles for the devices has been disclosed above, various embodiments consistent with the present disclosure may also be applicable to enterprises desiring to purchase mobile devices for their employees, members, participants, etc. An enterprise, as referenced herein, may include any entity having an organized information technology (IT) infrastructure. For example, enterprises may comprise businesses (e.g., partnerships, corporations, etc.), educational institutions (e.g., school systems, colleges, universities, etc.), medical institutions (e.g., hospitals), non-profit organizations (e.g., charities, professional associations), etc. As the abilities of mobile devices continue to increase, so does the interest of enterprises in making their IT infrastructure mobile.

However, this increase in IT infrastructure mobility also comes with an increase in complexity and risk. Many enterprises now employ resources dedicated to managing mobile device configuration and distribution. For example, new mobile devices must be configured so that they comprise enterprise directory information, can receive enterprise mail, can interact with enterprise applications, etc. From a security standpoint, mobile devices are designed to travel outside of the confines of the workplace, and so the risk of these devices being lost or stolen increases substantially. Moreover, users often desire to customize mobile devices with their own applications, data, peripherals (e.g., headsets, external storage, etc.). These inevitabilities increase the vulnerability of enterprise data stored on mobile devices to viruses, malware, theft through accessing stolen devices, etc.

In one embodiment, an enterprise device configuration system is disclosed. An example system may comprise an enterprise customization service (ECS) and a device. The ECS may be configured to provide at least one of configuration or software to the device based on enterprise customization data (ECD). The device may include at least an enterprise customization application (ECA) and the ECD. The ECA may be configured to cause the ECS to at least one of configure the device or to download software to the device based on the ECD.

The device may be a mobile device capable of at least wireless communication, and thus may further include, for example, transponder circuitry configured to wirelessly receive the ECD. Upon activation, the device may be configured to execute the ECA, which may be further configured to determine whether the device requires at least one of configuration or software from the ECS. For example, if it is determined by the ECA that at least one of configuration or software is required from the ECS, the ECA may provide the ECD to the ECS. The ECS may be configured to determine a package based on the ECD received from the device. A package may comprise, for example, information for configuring the device and/or software to download to the device.

In one embodiment, determining the package may comprise selecting the package from one or more predetermined packages in the ECS. For example, an enterprise may configure different packages in the ECS, with each package corresponding to a certain identifier. The ECD provided by the device to the ECS may include an identifier that the ECS may utilize to select the package. In the same or a different embodiment, the ECD may comprise an enterprise customization code (ECC). The ECC may include identifiers (e.g., concatenated, encoded, etc.) that may be employed in compiling a package from configuration information and/or software available in the ECS. For example, the ECS may parse an ECD to determine different features required for the device, and may then compile a package based on the required features. Regardless of how the package is determined, the ECS may then at least one of configure the device or download software to the device based on the determined package. Configuring the device may include, for example, configuring organizational features, connectivity features or security features in the device.

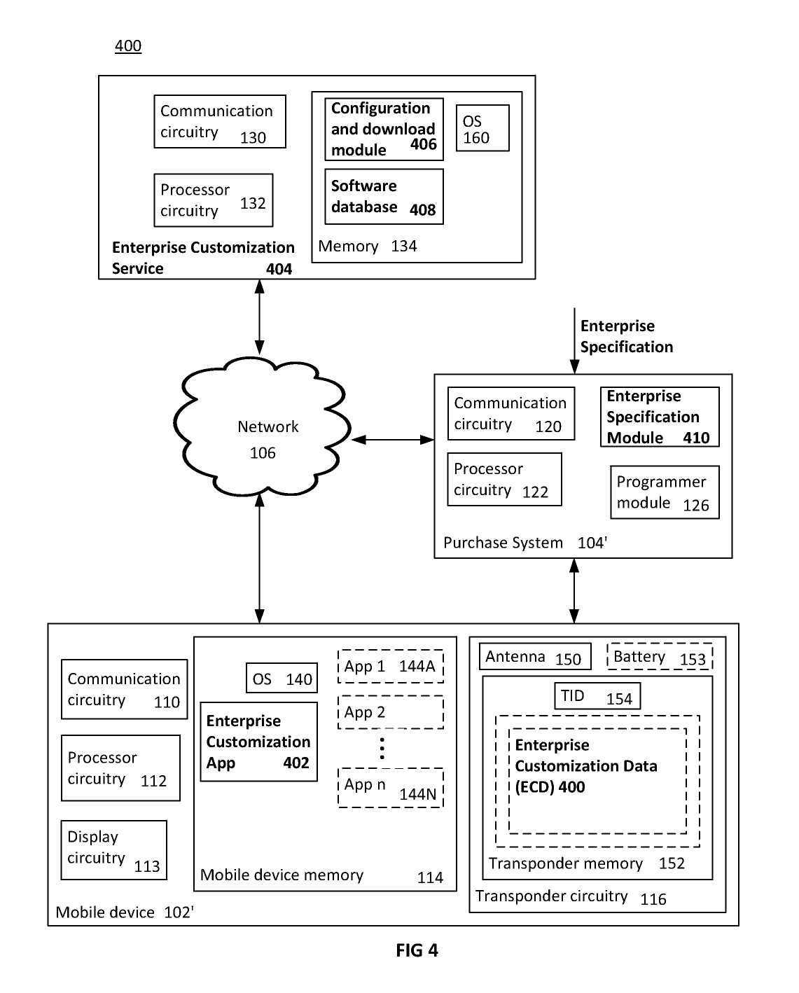

FIG. 4 illustrates an enterprise device configuration system 400 consistent with various embodiments of the present disclosure. FIG. 1 is similar to FIG. 4, and thus, elements that are the same in both figures will not be explained again. System 400 may include, for example, mobile device 102′, purchase system 104′ and ECS 404. Mobile device 102′ may be similar to mobile device 102 in FIG. 1 except that bundle access app 142 may be replaced by ECA 402 and bundle ID 156 may be replaced by ECD 400. ECA 402 may serve as a device-side customization agent while ECD 400 may comprise the information used by ECA 402 to customize mobile device 102′. In one embodiment, mobile device 102′ may be configured to execute ECA 402 when activated (e.g., powered up, turned on, booted, rebooted, etc.). ECA 402 may be configured to initially determine whether mobile device 102′ requires configuration and/or software. For example, upon executing ECA 402 may determine whether ECD 400 is missing from mobile device 102′, whether ECD 400 has changed from the last ECD recorded in in mobile device 102′, etc. Changes in ECD 400 may be determined by, for example, comparing current ECD 400 to a previously saved ECD 400, through the setting of an ECD change bit in mobile device 102′, etc. In one embodiment, if ECD 400 is determined to be missing, ECA 402 may cause mobile device 102′ to notify the device user and/or take corrective action. For example, ECA 402 may cause mobile device 102′ to display a message indicating that, for example, configuration must be performed before use, to issue an audible alert, to flash an indicator, etc. Moreover, ECA 402 may cause mobile device 102′ to notify the enterprise (e.g., via message, email, etc. to the enterprise IT group), so that corrective action may be conducted by the enterprise. On the other hand, if ECA 402 determines that configuration and/or software are required, then ECA 402 may cause device 102′ to engage ECS 404 via, for example, network 106. In one embodiment, ECA 402 may also initiate at least some configuration of mobile device 102′ based only on information contained in ECD 400. For example, ECD 400 may contain information such as, for example, bit settings indicating to ECA 402 that certain communication or security features in mobile device 102′ should be configured.

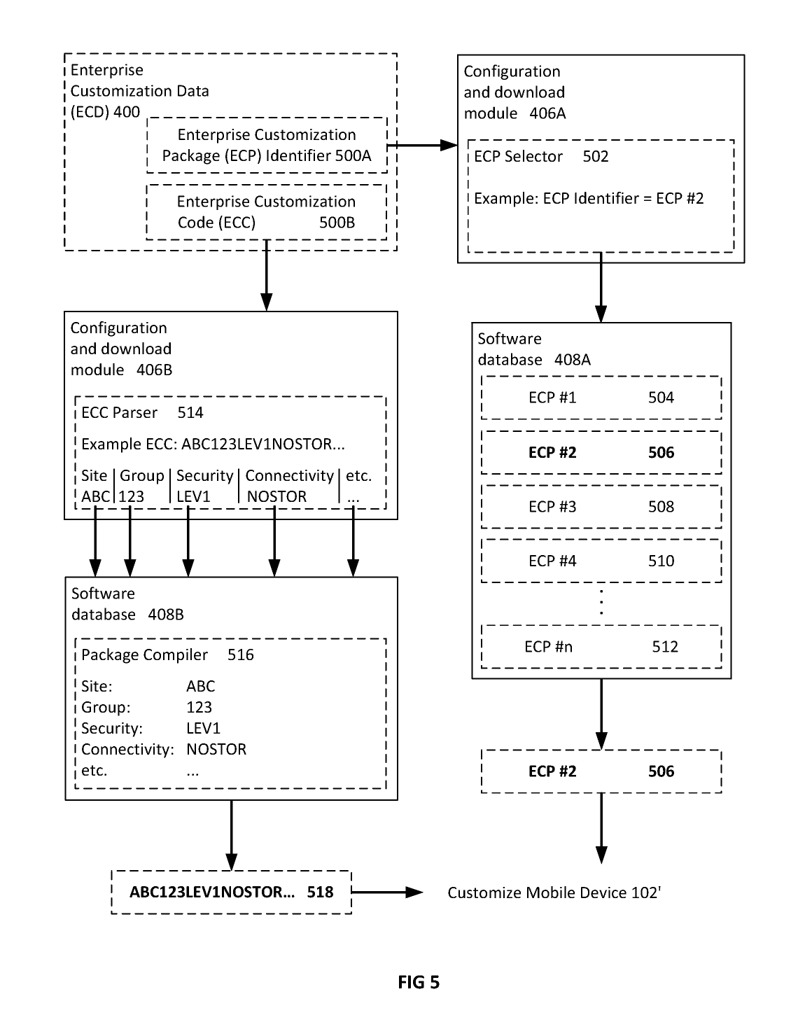

ECS 404 may be similar to bundle service 108 in FIG. 1 except for configuration and download module (CDM) 406 and software database 408. In at least one embodiment, ECS 404 is a “cloud” resource accessible via the Internet. CDM 406 may be configured to receive at least ECD 400 from mobile device 102′ (e.g., over a link in network 106 established by ECA 402). CDM 406 may determine a package based on ECD 400. An example package may contain information usable for configuring mobile device 102′ and/or software for download to mobile device 102′ (e.g., the package may select from software stored in software database 408 for download). After determining the package, CDM 406 may then cause ECS 404 to configure mobile device 102′ and/or to download software to mobile device 102′ via, for example, network 106. Examples of different methods by which packages may be determined are disclosed further in FIG. 5.

Purchase system 104′ may be similar to purchase system 104 in FIG. 1 except for enterprise specification module (ESM) 410. ESM 410 may receive an order for mobile device 102′ from an enterprise, wherein the order specifies a customization for mobile device 102′ (e.g., to be performed by ECS 404). For example, an enterprise may establish configuration information and/or software in ECS 404 (e.g., in CDM 406 and software database 408) for use in customizing mobile devices 102′ ordered directly from the device manufacturer, from an intermediary supplier (e.g., distributor, contractor, etc.), from a stock of generic (not customized) devices maintained within the enterprise, etc. The customization required for mobile device 102′ may be specified by ECD 400. For example, after the enterprise places an order, ECD 400 may be written to mobile device 102′ via wireless communication in a manner similar to that described above with respect to bundle ID 156 in FIG. 1-3. In one embodiment, after receiving an order ESM 410 may connect to ECS 404 via network 106, and may then cause ECS 404 to generate ECD 400 (e.g., based on the order) to a device equipped transfer the information to mobile device 102′. Alternatively, various characteristics of the end user (e.g., location, group, security requirements, etc.) may be provided to ESM 410, which may then formulate ECD 400, alone or with assistance from ECS 404, based on the characteristics of the end user. ECD 400 may be provided to mobile device 102′ during manufacturing, after placed into stock (e.g., in the box), when received at the enterprise, etc. At least one advantage of the manufacturer or intermediary supplier writing ECD 400 to mobile device 102′ is that the device may then be delivered directly to the end user without any involvement on the part of the enterprise. Alternatively, at least one advantage of an enterprise having the ability to write ECD 400 to mobile device 102′ is that, for example, the enterprise may reuse mobile device 102′ simply by changing ECD 400. Upon realizing that ECD 400 has changed, mobile device 102′ may re-customize the device for the next end user.

FIG. 5 illustrates examples of package determination consistent with various embodiments of the present disclosure. While two examples of package determination are disclosed in FIG. 5, the various embodiments are not limited to the disclosed examples, and may determine packages using other methodologies that are consistent with the present disclosure. ECD 400 may include information usable by ECS 404 for determining a package for use in configuring and/or providing software to mobile device 102′. In one example, ECD 400 may include an enterprise customization package (ECP) identifier 500A. ECP identifier 500A may be a unique predetermined identifier that is usable for selecting a package from one or more predetermined packages residing in ECS 404. For example, CDM 406A may include ECP selector 502 configured to utilize ECP identifier 500A in selecting a package from software database 408A (e.g., ECP #1 504 to ECP #n 512). In the example if FIG. 5, ECP identifier 500A indicates that ECP #2 506 should be selected, and thus, ECP #2 506 may be used to customize (e.g., configure and/or download software to) mobile device 102′.

In another example of package determination based on ECD 400, ECD 400 may include an enterprise customization code (ECC) 500B. ECC 500B is a code that may be parsed, decoded, decrypted, etc. into identifiers corresponding to end user characteristics that may be used to compile a package “from scratch” (e.g., from component parts in lieu of predetermined packages). For example, CDM 406B may include ECC parser 514 that is configured to break down ECC 500B. In the example disclosed in FIG. 5, ECC 500B is “ABC123LEV1NOSTOR,” however, ECC 500B is not required to be alphanumeric. Instead, ECC 500B could be a string of binary information, wherein bits or groups of bits identify different end user characteristics. Returning to the example disclosed in FIG. 5,

ECC 500B may be parsed into segments indicating, for example, a site (e.g., location) for the end user, a group (e.g., specialty, job, role, etc. at the enterprise), and a security level. In this instance it is evident that the end user works at site “ABC” in group “123” and has a security level of “1”. Moreover, information about permitted functionality for mobile device 102′ may be included in ECC 500B. For example, in the category “connectivity” a segment stating “NOSTOR” may indicate that storage devices may not be connected to mobile device 102′. Other information may also be included in ECC 406B to identify, for example, specific applications that may be required on mobile device 102′, directories (e.g., enterprise contact lists) that may be required on mobile device 102′, a need for one or more special travel provisions (e.g., international connectivity for end users that travel overseas regularly), etc. Software database 408B may utilize the information derived from parsing ECC 500B to compile a package. For example, software database 408B may include package compiler 516 configured to compile a package based on the end user characteristics derived from ECC 500B. The compiled package (e.g., package ABC123LEV1NOSTOR) may then be used to configure and/or download software to mobile device 102′.

Regardless of how a package is determined by ECS 404, the determined package may then be used to configure and/or provide software to mobile device 102′. However, it is important to note that “configuration,” as referenced herein, may occur before and/or after mobile device 102′ establishes a connection to ECS 404. In one embodiment, ECD 400 may include information (e.g., bits, codes, strings, etc.) usable for configuring mobile device 102′ prior to connecting to ECS 404. For example, upon activation mobile device 102′ may execute ECA 402, which may be configured to determine the presence of ECD 400. If ECD 400 is determined to be present, ECA 402 may then process ECD 400 (e.g., read, parse, etc.) to determine if immediate configuration is required prior to contacting ECS 404. Immediate configuration may include, for example, enabling/disabling various features in mobile device 102′ to prepare mobile device 102′ for further configuration by ECS 404 and/or to receive software, as an immediate security precaution to guard against malware, theft, etc. For example, immediate configuration may enable anti-theft tracking features in mobile device 102′. Regardless of whether “pre-configuration” is performed as described above, ECA 402 may then cause mobile device 102′ to connect to ECS 404. Configuration by ECS 404 may include, for example, the provision of executable files to mobile device 102′ in accordance with the package. For example, upon execution the files may cause organizational features, connectivity features and/or security features to be set in mobile device 102′. Examples of setting organizational features may include populating contact lists with enterprise information, altering graphical elements (e.g., icons, wallpapers, forms, etc.) based on enterprise banners or logos, etc. Examples of setting connectivity features may include providing mobile device 102′ with a unique network identification, access point (AP) passwords, server addresses, mail addresses, etc. Examples of setting security features may include configuring mobile device 102′ to prevent the installation of software other than that provided by the enterprise, to block external storage devices from downloading information off mobile device 102′, to lock out certain parameters from being changed, or utilities from being accessed, by the end user, etc. Software, as referenced herein, may include generally available or proprietary applications, databases, etc. used by the enterprise to be installed on mobile device 102′.

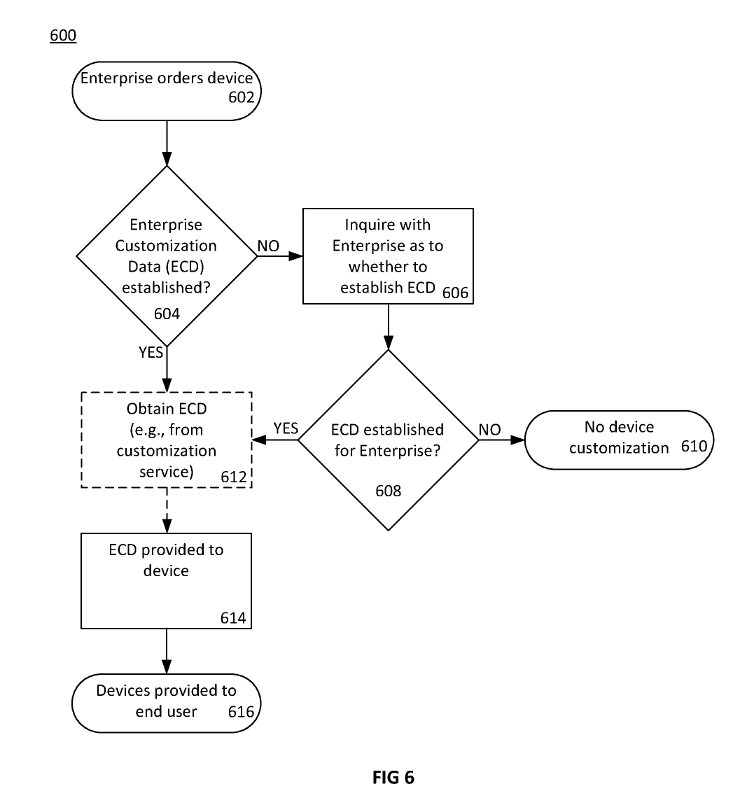

FIG. 6 illustrates a flowchart 600 of exemplary operations for procuring devices consistent with an embodiment of the present disclosure. In operation 602 an enterprise may order a device. The enterprise may order the device from the manufacturer, from an intermediary supplier, from an enterprise internal stock etc. A determination may then be made in operation 604 as to whether ECD has been established for the ordered device. If in operation 604 it is determined that the ECD has not been established for the ordered device, then in operation 606 an inquiry may be made to the enterprise as to whether to newly establish ECD for the ordered device. In operation 608 a determination may again be made as to whether the ECD has been established for the ordered device. If it is determined in operation 608 that the ECD has not been established, then in operation 610 the device may be provided to the enterprise without customization. Otherwise, if it is determined in operations 604 or 608 that the ECD has been established for the ordered device, then in operations 612-614 the ECD may be provided to the device.

In optional operation 612 the ECD for the ordered device may be obtained (e.g., from a customization service). For example, the purchase system that received the order may request an ECD from the customization service via a network link. Operation 612 may be optional in that, in at least one embodiment consistent with the present disclosure, it may be possible for the purchase system to generate the ECD. In operation 614 the ECD may then be provided to the device. For example, the ECD may be transmitted to the device via close-proximity wireless communication (e.g., radio frequency (RF) communication such as RF Identification (RFID) or Near Field Communication (NFC), infrared (IR) communication, high frequency (HF) communication, ultra high frequency (UHF) communication, etc.). The device, now including the ECD, may then be provided to the end user in operation 616.

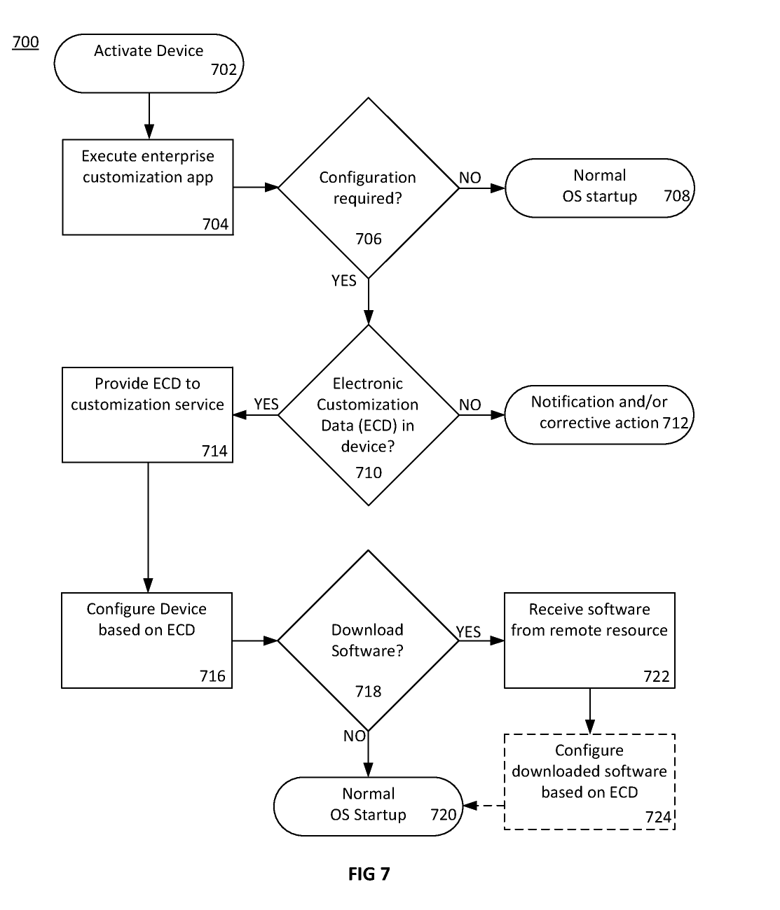

FIG. 7 illustrates a flowchart 700 of exemplary operations for providing enterprise configuration data to devices consistent with an embodiment of the present disclosure. In operation 702 a device may be activated. The device may then be configured to activate an enterprise customization application (“app”) in operation 704. A determination may then be made in operation 706 as to whether configuration is required in the device. For example the enterprise customization app may be configured to make the determination based on enterprise customization data in the device. If in operation 706 it is determined that configuration is not required, then in operation 708 the device may proceed to startup normally (e.g., the device may be permitted to boot into a device operating system (OS)).

If in operation 706 it is determined that configuration is required, the in operation 710 a further determination may be made as to whether ECD exists in the device. If it is determined that ECD does not exist in the device, then in operation 712 a notification may be presented (e.g., to the device user) and/or corrective action may be undertaken (e.g., to provide ECD to the device). If it is determined in operation 710 that ECD exists in the device, then in operation 714 the ECD may be provided to a customization service. For example, the customization application may cause the device to establish a network link to the customization service over which the ECD may be provided. The device may then be configured based on the ECD in operation 716. Configuration may be performed by the device alone (e.g., by the customization app deriving configuration parameters from the ECD) or in conjunction with information provided by the customization service. In operation 718 a determination may be made as to whether customization requires that software be downloaded to the device from the customization service. If it is determined in operation 718 that there is no software that needs to be downloaded, then in operation 720 the device may proceed to startup normally. Alternatively, if in operation 718 it is determined that software needs to be downloaded to the device, the device may receive software from the customization service in operation 722 and may optionally configure the downloaded software based on the ECD (e.g., if further configuration is necessary) in operation 724. The device may then proceed to startup normally in operation 720.

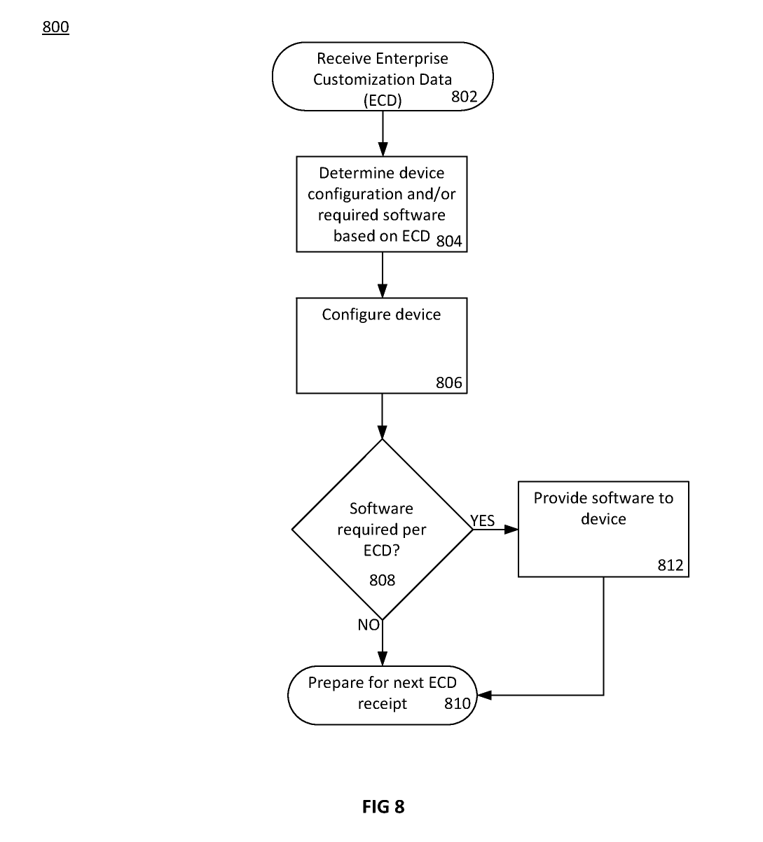

FIG. 8 illustrates a flowchart 800 of exemplary operations for customizing a device consistent with an embodiment of the present disclosure. In operation 802 ECD may be received from a device (e.g., in a customization service). In operation 804 configuration and/or software required for the device may then be determined based on the received ECD. Device configuration may proceed in operation 806. For example, executable files may be provided to the device that, when executed, cause the device to set various configurations (e.g., organizational features, connectivity features or security features. A determination may then be made in operation 808 as to whether software is to be provided to the device. If it determined in operation 808 that no software is to be provided to the device, then in operation 810 preparations may be made to receive the next ECD (e.g., from another device). Otherwise, if in operation 808 it is determined that software is to be provided to the device, then the software required for customizing the device may be provided in operation 812 before proceeding to operation 810.

While FIGS. 2, 3 and 6-8 illustrate various operations according various embodiments, it is to be understood that not all of the operations depicted in FIGS. 2, 3 and 6-8 are necessary for other embodiments. Indeed, it is fully contemplated herein that in other embodiments of the present disclosure, the operations depicted in FIGS. 2, 3 and 6-8 and/or other operations described herein may be combined in a manner not specifically shown in any of the drawings, but still fully consistent with the present disclosure. Thus, claims directed to features and/or operations that are not exactly shown in one drawing are deemed within the scope and content of the present disclosure.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical locations. The storage medium may include any type of tangible medium, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

Mobile device 102 and purchase system 104 may be configured to communicate with network 106 and/or bundle service 108 using a variety of communication protocols. The communications protocols may include but are not limited to wireless communications protocols, such as NFC, RFID, Wi-Fi, Bluetooth, 3G, 4G and/or other communication protocols. Purchase system 104 may generally be configured to communicate with mobile device 102 using communication protocols configured for generally local communication. The local communication protocols may include but are not limited to NFC, RFID and Bluetooth. The Wi-Fi protocol may comply or be compatible with the 802.11 standards published by the Institute of Electrical and Electronics Engineers (IEEE), titled “IEEE 802.11-2007 Standard, IEEE Standard for Information Technology-Telecommunications and Information Exchange Between Systems-Local and Metropolitan Area Networks-Specific Requirements—Part 11: Wireless LAN Medium Access Control (MAC) and Physical Layer (PHY) Specifications” published, Mar. 8, 2007, and/or later versions of this standard.

The NFC and/or RFID communication signal and/or protocol may comply or be compatible with one or more NFC and/or RFID standards published by the International Standards Organization (ISO) and/or the International Electrotechnical Commission (IEC), including ISO/IEC 14443, titled: Identification cards—Contactless integrated circuit cards—Proximity cards, published in 2008; ISO/IEC 15693: Identification cards—Contactless integrated circuit cards—Vicinity cards, published in 2006, titled: ISO/IEC 18000, titled: Information technology—Radio frequency identification for item management, published in 2008; and/or ISO/IEC 18092, titled: Information technology—Telecommunications and information exchange between systems—Near Field Communication—Interface and Protocol, published in 2004; and/or later versions of these standards.

The Bluetooth protocol may comply or be compatible with the 802.15.1 standard published by the IEEE, titled “IEEE 802.15.1-2005 standard, IEEE Standard for Information technology—Telecommunications and information exchange between systems—Local and metropolitan area networks—Specific requirements Part 15.1: Wireless Medium Access Control (MAC) and Physical Layer (PHY) Specifications for Wireless Personal Area Networks (W Pans)”, published in 2005, and/or later versions of this standard.

The 3G protocol may comply or be compatible with the International Mobile Telecommunications (IMT) standard published by the International Telecommunication Union (ITU), titled “IMT-2000”, published in 2000, and/or later versions of this standard. The 4G protocol may comply or be compatible with IMT standard published by the ITU, titled “IMT-Advanced”, published in 2008, and/or later versions of this standard.

For example, network 106 may comprise a packet switched network. Mobile device 102 and purchase system 104 may be capable of communicating with the bundle service 108 using a selected packet switched network communications protocol. One exemplary communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and

Electronics Engineers (IEEE) titled “IEEE 802.3 Standard”, published in March, 2002 and/or later versions of this standard. Alternatively or additionally, mobile device 102 and purchase system 104 may be capable of communicating with the bundle service 108 using an X.25 communications protocol. The X.25 communications protocol may comply or be compatible with a standard promulgated by the International Telecommunication Union-Telecommunication Standardization Sector (ITU-T). Alternatively or additionally, mobile device 102 and purchase system 104 may be capable of communicating with the bundle service 108 using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, mobile device 102 and purchase system 104 may be capable of communicating with the bundle service 108 using an Asynchronous Transfer Mode (ATM) communications protocol. The ATM communications protocol may comply or be compatible with an ATM standard published by the ATM Forum titled “ATM-MPLS Network Interworking 1.0” published August 2001, and/or later versions of this standard. Of course, different and/or after-developed connection-oriented network communication protocols are equally contemplated herein.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Thus, the present disclosure generally relates to a system and method for enterprise device customization. An example system may comprise an enterprise customization service and a device. The enterprise customization service may be configured to provide at least one of configuration or software to the device based on enterprise customization data. The device may include at least an enterprise customization application and the enterprise customization data. The enterprise customization application may be configured to cause the enterprise customization service to at least one of configure the device or to download software to the device based on the enterprise customization data.

The following examples pertain to further embodiments. Example 1 may include a device for use with an enterprise device configuration system, comprising enterprise customization data, and an enterprise customization application configured to cause an enterprise customization service external to the device to at least one of configure the device or download software to the device based on the enterprise customization data.

Example 2 may include the subject matter of example 1 and may further comprise a communication module configured to allow the enterprise customization application to communicate with at least the enterprise customization service via wired or wireless communication. Optionally, example 2 may further comprise the communication module comprising transponder circuitry being configured to wirelessly receive the enterprise customization data.

Example 3 may include the subject matter of examples 1 or 2 and may further comprise the enterprise customization application being further configured to execute upon device activation and to determine whether the device requires at least one of configuration or a software download from the enterprise customization service.

Example 4 may include an enterprise customization service comprising at least one server configured to receive enterprise customization data from a device and to at least one of configure the device or download software to the device based on a package corresponding to the enterprise customization data.

Example 5 may include the subject matter of example 4 and may further comprise the package being one of a plurality of packages predetermined in the at least one server and the at least one server is further configured to select the package from the plurality of packages based on an identifier in the enterprise customization data.

Example 6 may include the subject matter of example 4 or 5 and may further comprise the at least one server being further configured to compile the package based on the enterprise customization data. Optionally, example 6 may further comprise the enterprise customization data comprising an enterprise customization code, the at least one server being further configured to compile the package based on the enterprise customization code. Optionally, example 6 may further comprise the at least one server being further configured to parse the enterprise customization code to determine at least one of configuration information or software to include in the package.

Example 7 may include a method for configuring a device using an enterprise device configuration system comprising determining by the device whether at least one of configuration or software is required in the device based on enterprise customization data, and performing device customization if it is determined that at least one of configuration or software is required in the device.

Example 8 may include the subject matter of example 7 and may further comprise determining by the device whether at least one of configuration or software is required comprising executing an enterprise customization application in the device configured to determine whether enterprise customization data exists in the device; and provide the enterprise customization data to an enterprise customization service if it is determined enterprise customization data exists in the device. Optionally, example 8 may further comprise performing device customization comprising configuring at least one of organizational features, connectivity features or security features in the device based on the enterprise customization data. Optionally, example 8 may further comprise performing device customization comprising receiving software at the device from the enterprise customization service, the software being based upon the enterprise customization data.

Example 9 may include a method for configuring a device using an enterprise device configuration system, comprising receiving enterprise customization data from a device at an enterprise customization service, determining by the enterprise customization service at least one of configuration or software that is required in the device based on the enterprise customization data; and providing at least one of the configuration or the software to the device from the enterprise customization service.

Example 10 may include the subject matter of example 9 and may further comprise determining by the enterprise customization service at least one of configuration or software that is required comprising determining a package including at least one of information for configuring the device or software to download to the device. Optionally, example 10 may further comprise determining the package comprising selecting a predetermined package based on an identifier in the enterprise customization data. Optionally, example 10 may further comprise determining the package comprising compiling a package based on an enterprise customization code in the enterprise customization data. Optionally, example 10 may further comprise compiling the package comprising parsing the enterprise customization code to determine at least one of information used to configure the device or software to download to the device.

Example 11 may include the subject matter of example 9 or 10 and may further comprise providing at least one of the configuration or the software to the device from the enterprise customization service comprising configuring at least one of organizational features, connectivity features or security features in the device based on the enterprise customization data.

Example 12 may comprise a system including at least an enterprise customization service and a device, the system being arranged to perform the method of any of the examples 7-11.

Example 13 may comprise a chipset arranged to perform the method of any of the examples 7-11.

Example 14 may comprise at least one machine readable medium comprising a plurality of instructions that, in response to be being executed on a computing device, cause the computing device to carry out the method according to any one of examples 7-11.

Example 15 may comprise a device configured for enterprise device configuration, the device being arranged to perform the method of any one of examples 7-8.

Example 16 may comprise a service configured for enterprise device configuration, the service being arranged to perform the method of any one of the examples 9-11.

Example 17 may comprise a device comprising means to perform the method of any one of the examples 7-11.

Example 18 may comprise at least one machine-readable storage medium having stored thereon individually or in combination, instructions that when executed by one or more processors result in the system carrying out any of the examples 7-11.

Example 19 may include a device for use with an enterprise device configuration system, comprising enterprise customization data, and an enterprise customization application configured to cause an enterprise customization service external to the device to at least one of configure the device or download software to the device based on the enterprise customization data.

Example 20 may include the subject matter of example 19 and may further comprise a communication module configured to allow the enterprise customization application to communicate with at least the enterprise customization service via wired or wireless communication, the communication module comprising transponder circuitry configured to wirelessly receive the enterprise customization data.

Example 21 may include the subject matter of examples 19 or 20 and may further comprise the enterprise customization application being further configured to execute upon device activation and to determine whether the device requires at least one of configuration or a software download from the enterprise customization service.

Example 22 may include an enterprise customization service, comprising at least one server configured to receive enterprise customization data from a device and to at least one of configure the device or download software to the device based on a package corresponding to the enterprise customization data.

Example 23 may include the subject matter of example 22 and may further comprise the package being one of a plurality of packages predetermined in the at least one server and the at least one server is further configured to select the package from the plurality of packages based on an identifier in the enterprise customization data.

Example 24 may include the subject matter of examples 22 or 23 and may further comprise the at least one server being further configured to compile the package by parsing an enterprise customization code in the enterprise customization data to determine at least one of configuration information or software to include in the package.

Example 25 may include a method for configuring a device using an enterprise device configuration system, comprising determining by the device whether at least one of configuration or software is required in the device based on enterprise customization data; and performing device customization if it is determined that at least one of configuration or software is required in the device.

Example 26 may include the subject matter of example 25 and may further comprise determining by the device whether at least one of configuration or software is required comprising executing an enterprise customization application in the device configured to determine whether enterprise customization data exists in the device; and provide the enterprise customization data to an enterprise customization service if it is determined enterprise customization data exists in the device.

Example 27 may include a method for configuring a device using an enterprise device configuration system, comprising receiving enterprise customization data from a device at an enterprise customization service determining by the enterprise customization service at least one of configuration or software that is required in the device based on the enterprise customization data, and providing at least one of the configuration or the software to the device from the enterprise customization service.

Example 28 may include the subject matter of example 27 and may further comprise determining by the enterprise customization service at least one of configuration or software that is required comprises determining a package including at least one of information for configuring the device or software to download to the device. Optionally, example 28 may further comprise determining the package comprising selecting a predetermined package based on an identifier in the enterprise customization data. Optionally, example 28 may further comprise determining the package comprising compiling a package by parsing an enterprise customization code in the enterprise customization data to determine at least one of information used to configure the device or software to download to the device.

Example 29 may include a system including at least an enterprise customization service and a device, the system being arranged to perform the method of any of the examples 25-28.

Example 30 may include a chipset arranged to perform the method of any of the examples 25-28.

Example 31 may include at least one machine readable medium comprising a plurality of instructions that, in response to be being executed on a computing device, cause the computing device to carry out the method according to any one of examples 25-28.

Example 32 may include a device for use with an enterprise device configuration system, comprising enterprise customization data, and an enterprise customization application configured to cause an enterprise customization service external to the device to at least one of configure the device or download software to the device based on the enterprise customization data.

Example 33 may include the subject matter of example 32 and may further comprise a communication module configured to allow the enterprise customization application to communicate with at least the enterprise customization service via wired or wireless communication. Optionally, example 33 may further comprise the communication module comprising transponder circuitry being configured to wirelessly receive the enterprise customization data.

Example 34 may include the subject matter of examples 32 or 33 and may further comprise the enterprise customization application being further configured to execute upon device activation and to determine whether the device requires at least one of configuration or a software download from the enterprise customization service.

Example 35 may include an enterprise customization service, comprising at least one server configured to receive enterprise customization data from a device and to at least one of configure the device or download software to the device based on a package corresponding to the enterprise customization data.

Example 36 may include the subject matter of example 35 and may further comprise the package being one of a plurality of packages predetermined in the at least one server and the at least one server is further configured to select the package from the plurality of packages based on an identifier in the enterprise customization data.

Example 37 may include the subject matter of example 35 or 36 and may further comprise the at least one server being further configured to compile the package based on the enterprise customization data. Optionally, example 37 may further comprise the enterprise customization data comprising an enterprise customization code, the at least one server being further configured to compile the package based on the enterprise customization code. Optionally, example 37 may further comprise the at least one server being further configured to parse the enterprise customization code to determine at least one of configuration information or software to include in the package.

Example 38 may include a method for configuring a device using an enterprise device configuration system, comprising determining by the device whether at least one of configuration or software is required in the device based on enterprise customization data, and performing device customization if it is determined that at least one of configuration or software is required in the device.

Example 39 may include the subject matter of example 38 and may further comprise determining by the device whether at least one of configuration or software is required comprising executing an enterprise customization application in the device configured to determine whether enterprise customization data exists in the device, and provide the enterprise customization data to an enterprise customization service if it is determined enterprise customization data exists in the device. Optionally, example 39 may further comprise performing device customization comprising configuring at least one of organizational features, connectivity features or security features in the device based on the enterprise customization data. Optionally, example 39 may further comprise performing device customization comprising receiving software at the device from the enterprise customization service, the software being based upon the enterprise customization data.

Example 40 may include a method for configuring a device using an enterprise device configuration system, comprising receiving enterprise customization data from a device at an enterprise customization service, determining by the enterprise customization service at least one of configuration or software that is required in the device based on the enterprise customization data, and providing at least one of the configuration or the software to the device from the enterprise customization service.

Example 41 may include the subject matter of example 40 and may further comprise determining by the enterprise customization service at least one of configuration or software that is required comprising determining a package including at least one of information for configuring the device or software to download to the device. Optionally, example 41 may further comprise determining the package comprising selecting a predetermined package based on an identifier in the enterprise customization data. Optionally, example 41 may further comprise determining the package comprising compiling a package based on an enterprise customization code in the enterprise customization data. Optionally, example 41 may further comprise compiling the package comprising parsing the enterprise customization code to determine at least one of information used to configure the device or software to download to the device.

Example 42 may include the subject matter of example 40 or 41 and may further comprise providing at least one of the configuration or the software to the device from the enterprise customization service comprising configuring at least one of organizational features, connectivity features or security features in the device based on the enterprise customization data.

Example 43 may include a device for use with an enterprise configuration system, comprising means for determining by the device whether at least one of configuration or software is required in the device based on enterprise customization data, and means for performing device customization if it is determined by the device that at least one of configuration or software is required in the device.

Example 44 may include the subject matter of example 43 and may further comprise determining by the device whether at least one of configuration or software is required comprising executing an enterprise customization application in the device configured to determine whether enterprise customization data exists in the device, and providing the enterprise customization data to an enterprise customization service if it is determined enterprise customization data exists in the device. Optionally, example 44 may further comprise performing device customization comprising configuring at least one of organizational features, connectivity features or security features in the device based on the enterprise customization data. Optionally, example 44 may further comprise performing device customization comprising receiving software at the device from the enterprise customization service, the software being based upon the enterprise customization data.

Example 45 may include an enterprise device configuration system, comprising means for receiving enterprise customization data from a device at an enterprise customization service, means for determining by the enterprise customization service at least one of configuration or software that is required in the device based on the enterprise customization data, and means for providing at least one of the configuration or the software to the device from the enterprise customization service.

Example 46 may include the subject matter of example 45 and may further comprise determining by the enterprise customization service at least one of configuration or software that is required comprising determining a package including at least one of information for configuring the device or software to download to the device. Optionally, example 46 may further comprise determining the package comprising selecting a predetermined package based on an identifier in the enterprise customization data. Optionally, example 46 may further comprise determining the package comprising compiling a package based on an enterprise customization code in the enterprise customization data. Optionally, example 46 may further comprise compiling the package comprising parsing the enterprise customization code to determine at least one of information used to configure the device or software to download to the device.

Example 47 may include the subject matter of example 45 or 46 and may further comprise providing at least one of the configuration or the software to the device from the enterprise customization service comprising configuring at least one of organizational features, connectivity features or security features in the device based on the enterprise customization data.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. A device for use with an enterprise device configuration system, comprising:
enterprise customization data; and
an enterprise customization application configured to cause an enterprise customization service external to the device to at least one of configure the device or download software to the device based on the enterprise customization data.

2. The device of claim 1, further comprising a communication module configured to allow the enterprise customization application to communicate with at least the enterprise customization service via wired or wireless communication.

3. The device of claim 2, wherein the communication module comprises transponder circuitry configured to wirelessly receive the enterprise customization data.

4. The device of claim 1, wherein the enterprise customization application is further configured to execute upon device activation and to determine whether the device requires at least one of configuration or a software download from the enterprise customization service.

5. An enterprise customization service, comprising:
at least one server configured to receive enterprise customization data from a device and to at least one of configure the device or download software to the device based on a package corresponding to the enterprise customization data.

6. The service of claim 5, wherein the package is one of a plurality of packages predetermined in the at least one server and the at least one server is further configured to select the package from the plurality of packages based on an identifier in the enterprise customization data.

7. The service of claim 5, wherein the at least one server is further configured to compile the package based on the enterprise customization data.

8. The service of claim 7, wherein the enterprise customization data comprises an enterprise customization code, the at least one server being further configured to compile the package based on the enterprise customization code.

9. The service of claim 8, wherein the at least one server is further configured to parse the enterprise customization code to determine at least one of configuration information or software to include in the package.

10. At least one machine-readable storage medium having stored thereon, individually or in combination, instructions that when executed by one or more processors result in the following operations comprising:
determining by a device whether at least one of configuration or software is required in the device based on enterprise customization data; and
performing device customization if it is determined by the device that at least one of configuration or software is required in the device.

11. The medium of claim 10, wherein determining by the device whether at least one of configuration or software is required comprises executing an enterprise customization application in the device configured to:
determine whether enterprise customization data exists in the device; and
provide the enterprise customization data to an enterprise customization service if it is determined enterprise customization data exists in the device.

12. The medium of claim 11, wherein performing device customization comprises configuring at least one of organizational features, connectivity features or security features in the device based on the enterprise customization data.

13. The medium of claim 11, wherein performing device customization comprises receiving software at the device from the enterprise customization service, the software being based upon the enterprise customization data.

14. At least one machine-readable storage medium having stored thereon, individually or in combination, instructions that when executed by one or more processors result in the following operations comprising:
receiving enterprise customization data from a device at an enterprise customization service;
determining by the enterprise customization service at least one of configuration or software that is required in the device based on the enterprise customization data; and
providing at least one of the configuration or the software to the device from the enterprise customization service.

15. The medium of claim 14, wherein determining by the enterprise customization service at least one of configuration or software that is required comprises determining a package including at least one of information for configuring the device or software to download to the device.

16. The medium of claim 15, wherein determining the package comprises selecting a predetermined package based on an identifier in the enterprise customization data.

17. The medium of claim 15, wherein determining the package comprises compiling a package based on an enterprise customization code in the enterprise customization data.

18. The medium of claim 17, wherein compiling the package comprises parsing the enterprise customization code to determine at least one of information used to configure the device or software to download to the device.

19. The medium of claim 14, wherein providing at least one of the configuration or the software to the device from the enterprise customization service comprises configuring at least one of organizational features, connectivity features or security features in the device based on the enterprise customization data.
